(19) United States
(12) Patent Application Publication
(10) Pub. No.: US 2006/0071380 A1
(43) Pub. Date: Apr. 6, 2006

(54) Vibration isolator

(75) Inventors: Hikofumi Yamamoto, Osaka-shi, Osaka (JP); Yoshio Ihara, Osaka (JP)

Correspondence Address: JORDAN AND HAMBURG LLP, 122 EAST 42ND STREET, SUITE 4000, NEW YORK, NY, 10168, US

(73) Assignee: Toyo Tire & Rubber Co., Ltd., Osaka-shi, Osaka (JP)

(21) Appl. No.: 10/511,979

(22) PCT Filed: Nov. 5, 2002
(86) PCT No.: PCT/JP02/11532

§ 371 Date: Oct. 20, 2004

(51) Int. Cl. F16F 9/00

(52) U.S. Cl. 267/140.11

(57) ABSTRACT

In order to provide a vibration-isolating device having a stopper mechanism to an excessive displacement of a vibration-isolating base in upward and horizontal directions with a light weight and a low cost, an inner cylinder and an attachment member with an opening surrounding it are connected by a rubber-like elastomer, a cylindrical portion is extended downwardly from the opening to form a stopper rubber between the cylindrical portion and the inner cylinder, while ensuring a clearance gap thereby providing a first stopper part limiting a horizontal displacement of the inner cylinder; and an extension portion extending from a lower end of the inner cylinder outwardly is provided to form a stopper rubber between the extension portion and a lower end of the cylindrical portion while ensuring a clearance gap thereby providing a second stopper part limiting an upward displacement of the inner cylinder.

### TECHNICAL FIELD

This invention relates to a vibration-isolating device mainly used for supporting and bearing a vibratory body such as an automotive engine, etc. in a vibration-proof manner.

### BACKGROUND ART

In a vibration-proof device, e.g. a mount, for supporting and bearing a vibratory body such as an automotive engine, etc. so as not to transmit its vibration to a support body such as a vehicle body a stopper mechanism is provided to prevent a deformation exceeding a definite limit of a vibration-isolating base which is a rubber elastomer, and for the stopper mechanism, a variety of structures have been proposed hitherto (cf., for example, JP Patent Application Publication 10-9330 A).

FIG. 8 illustrates one example of such a conventional vibration-isolating device. This vibration-isolating device comprises an upper attachment member 101 to be attached to an engine side as a vibrating body, a lower attachment member 102 to be attached to a vehicle body side as a support body, and a vibration-isolating base made of a rubber-like elastomer 103 interposed between the upper attachment member 101 and the lower attachment member 102 to connect the both members, and is constructed so that the vibration-isolating base 103 may support the upper attachment member 101 to the lower attachment member 102 elastically in the vertical direction. On the upper part of the upper attachment member 101 there is provided a protrusion part 105 for a stopper projecting outwardly and encapsulated by a stopper rubber 104. Further a stopper fitting 106 assuming a generally omega form is disposed to be spaced apart a predetermined clearance gap from the upside and both lateral sides of the stopper protrusion part 105 in a manner covering it. The stopper fitting 106 is adapted to be secured to the vehicle body together with the lower attachment fitting 102.

With this prior art vibration-isolating device, against an excessive displacement in the horizontal direction of the upper attachment member 101 and the lower attachment member 102, more specifically in the fore and aft direction of the vehicle, the lateral sides of the stopper protrusion part 105 abut on a sidewall 106A of the stopper fitting 106 thereby regulating a displacement in excess of a definite amount. On the other hand, against an upward excessive displacement of the upper attachment member 101, the upside of the stopper protrusion part 105 abuts on an upper wall 106B of the stopper fitting 106, thereby regulating a displacement beyond a definite amount.

Of late, there is a strong demand to a low fuel consumption and a low cost of automobiles and consequently, requests from automobile manufacturers to automotive parts for reducing the weight and cost of them become more and more severe day by day. Under the circumstances, the above-mentioned conventional vibration-isolating device cannot meet sufficiently the requests for reduction in weight and cost thereof, because a stopper action to excessive displacements in the upward and horizontal directions is exhibited by the omega-shaped stopper fitting.

### DISCLOSURE OF THE INVENTION

In view of the respects described above, this invention has been made, and accordingly, it is an object of the invention to provide a vibration-isolating device having a stopper mechanism to excessive displacements in the upward and horizontal directions of a vibration-isolating base with a reduced weight and a reduced cost.

The vibration-isolating device of this invention which connects a vibratory body to a support body in a vibration-proof manner comprises a first attachment member having a shank portion to be attached to the vibratory body side, the shank portion being disposed with its axis direction oriented in the vertical direction; a second attachment member having an opening surrounding the shank portion to be attached to the support body side; a vibration-isolating base interposed between the shank portion of the first attachment member and the opening of the second attachment member to connect both thereby supporting elastically the first attachment member to the second attachment member in the vertical direction, wherein a cylindrical portion extending from an opening edge of the opening downwardly is disposed and a first stopper rubber is formed between the cylindrical portion and the shank portion, while ensuring a clearance gap in a square direction to the axis direction, thereby providing a first stopper part limiting displacement in the horizontal direction of the first attachment member and the second attachment member; and an extension portion extending from a lower end of the shank portion to face outwardly beneath the cylindrical portion is disposed and a second stopper rubber is formed between the extension portion and the lower end of the cylindrical portion, while ensuring a clearance gap in the axis direction, thereby providing a second stopper part limiting an upward displacement of the first attachment member toward the second attachment member.

According to the vibration-isolating device of this invention, the first stopper part regulating an excessive displacement in the horizontal direction of the vibration-isolating base is thus provided between the shank portion of the first attachment member and the cylindrical portion of the second attachment member surrounding the former and concurrently, the second stopper part regulating an upward excessive displacement of the vibration-isolating base is provided between the extension portion extending from the lower end of the shank portion and the lower end of the cylindrical portion. Because of the provision of both, such an omega-shaped stopper fitting as before is no longer needed and consequently, a reduction in weight and cost of the vibration-isolating device can be achieved.

In the vibration-isolating device of this invention, the first stopper rubber may be provided by a rubber extending from the vibration-isolating base so as to cover the inner peripheral face of the cylindrical portion while the second stopper rubber may be provided by a rubber extending from the first stopper rubber so as to cover the underside of the cylindrical portion. The first stopper rubber and the second stopper rubber are thus formed by the rubber integral with and extending from the rubber of the vibration-isolating base, whereby a further cost reduction can be attained.

In the vibration-isolating device of this invention, it is further possible to provide a third stopper rubber on an upside of the second attachment member in the vicinity of the opening and at the same time to provide the first attachment member with a stopper receiving portion opposing the third stopper rubber through the medium of a clearance gap thereto, thereby providing a third stopper part limiting a downward displacement of the first attachment member toward the second attachment member.

Again in the vibration-isolating device of this invention, the first attachment member may be comprised of an inner cylinder, which is the aforesaid shank portion, and of a bracket connecting the inner cylinder to the vibratory body side, wherein the bracket is fastened to an upper end of the inner cylinder by means of a bolt entered internally through the inner cylinder, and a plate-like stopper member may be fastened to a lower end of the inner cylinder by means of the bolt, the aforesaid extension portion being formed by the stopper member In this case, the inner cylinder may be fashioned by a press working of a metal plate to assume a cylindrical form surrounding the bolt, leaving a clearance or void, wherein the inner cylinder comprises a bottom plate portion having a through-hole for the bolt at its lower end and an outwardly facing flange portion abutting on the underside of the bracket at its upper end, whereby a further weight reduction of the vibration-isolating device is attainable.

Further the vibration-isolating device according to the invention may be constructed so that the first attachment member is provided with a bracket connecting the shank portion to the vibratory body side; the shank portion is comprised of a first inner cylinder that is connected through the vibration-isolating base to the second attachment member and of a second inner cylinder that forms the first stopper part between it and the cylindrical portion of the second attachment member and has the extension portion at its lower end; the bracket is fastened to the upper end of the first inner cylinder by a bolt entered internally through the first inner cylinder, with which bolt the second inner cylinder is fastened to the first inner cylinder at its lower end. Here, the first inner cylinder may be configured by a press working of a metal plate so as to assume a cylindrical form surrounding the bolt while leaving a void, wherein the first inner cylinder comprises a bottom plate portion having a through hole for the bolt at its lower end and an outwardly facing flange portion abutting on the underside of the bracket at its upper end, whereby further reduction in weight of the vibration-isolating base can be achieved.

### BRIEF DESCRIPTION OF THE DRAWINGS

FIG. 1 is a plan view of a vibration-isolating device pertaining to a first embodiment of this invention;

FIG. 2 is a sectional view taken along II-II line of FIG. 1;

FIG. 3 is a side elevation as viewed from the direction of an arrow mark III in FIG. 1;

FIG. 4 is a side elevation as viewed from the direction of an arrow mark IV in FIG. 1;

FIG. 5 is a sectional view of a vibration-isolating device pertaining to a second embodiment of this invention;

FIG. 6 is a sectional view of a vibration-isolating device pertaining to a third embodiment of this invention;

FIG. 7 is a sectional view of a vibration-isolating device pertaining to a fourth embodiment of this invention; and

FIG. 8 is a sectional view of a conventional vibration-isolating device.

### BEST MODE FOR CARRYING OUT THE INVENTION

The vibration-isolating device relating to embodiments of this invention will be hereinafter described with reference to the accompanying drawings.

### First Embodiment

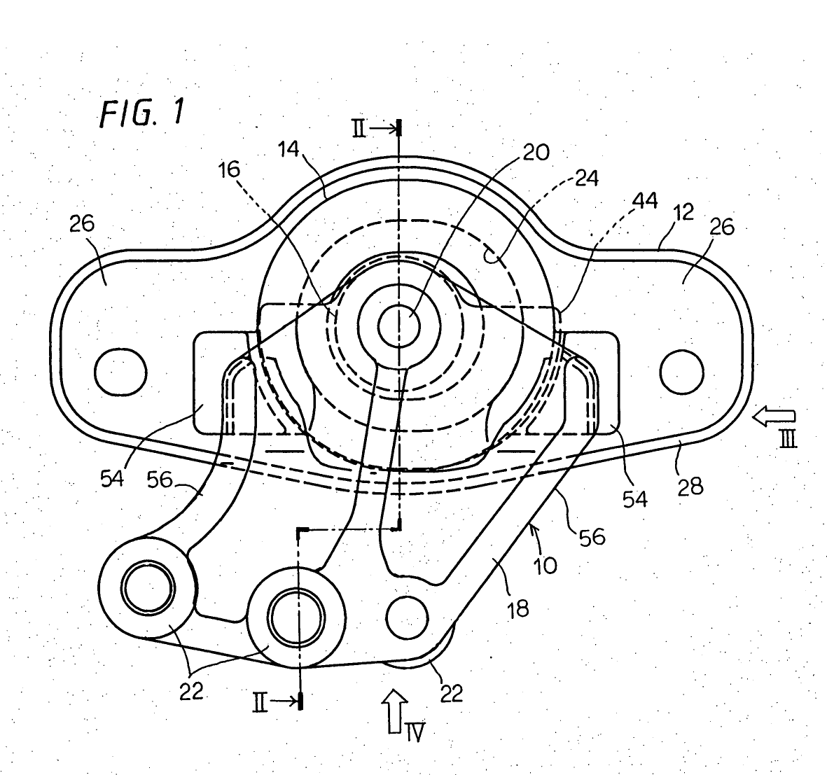

A first embodiment will be described with reference to FIGS. 1 to 4.

The vibration-isolating device in this embodiment is an engine mount supporting and bearing the right-hand part of an engine for FF (Front engine/Front wheel drive) vehicles to a vehicle body side member in a vibration-proof manner. In FIG. 1 the direction indicated by the arrow mark III is a front side of the vehicle.

This vibration-isolating device comprises a first attachment member 10 made of metal to be fitted to an engine as a vibratory body, a second attachment member 12 made of metal to be fitted to a vehicle body member as a support body, and a vibration-isolating base 14 made of rubber-like elastomer interposed between the first attachment member 10 and the second attachment member 12 to connect the both in a vibration-proof manner.

The first attachment member 10 includes an inner cylinder 16 vertically disposed as a shank portion and a bracket 18 connecting the inner cylinder 16 to the engine. The inner cylinder 16 is constructed of a cylinder body made of metal, with its axis direction oriented in the vertical direction and entered by a bolt 20 from its underside. By the instrumentality of the bolt 20, the bracket 18 is fastened to the inner cylinder 16 at its upper end. The bracket 18 is provided with fitting parts 22 to the engine in a position distant from its joint portion to the inner cylinder 16 in a normal-to-axis direction.

The second attachment member 12 assuming a flat plate-like form is defined with a generally circular opening 24 in a central part thereof, in which the inner cylinder 16 is inserted from upwardly, and provided at its two diametrically opposite places with attachment face portions 26 to a vehicle body. A peripheral portion 28 of the second attachment member 12 is configured in a flange shape bent upwardly for reinforcement purpose.

The opening 24 of the second attachment member 12 encircles nearly coaxially the inner cylinder 16, with its opening edge formed as a tapered face portion slanting inwardly and downwardly. From the tapered face portion 30 at its lower end, a short cylindrical portion 32 extends downwardly, and a lower end of the cylindrical portion 32 is formed as a flange portion 34 bent outwardly.

The vibration-isolating base 14 assuming a generally umbrella shape links the inner cylinder 16 and the opening 24 of the second attachment member 12 together, thereby elastically supporting the first attachment member 10 to the second attachment member 12 in the vertical direction. Specifically stated, the vibration-isolating base 14 interconnects the tapered face portion 30 of the second attachment member 12 and the peripheral face of the inner cylinder 16 upward of the tapered face portion. The vibration-isolating base 14 in this embodiment is fixed to both the inner cylinder 16 and the second attachment member 12 by vulcanization bonding means, but can also be secured by alternative means such as press fitting, etc.

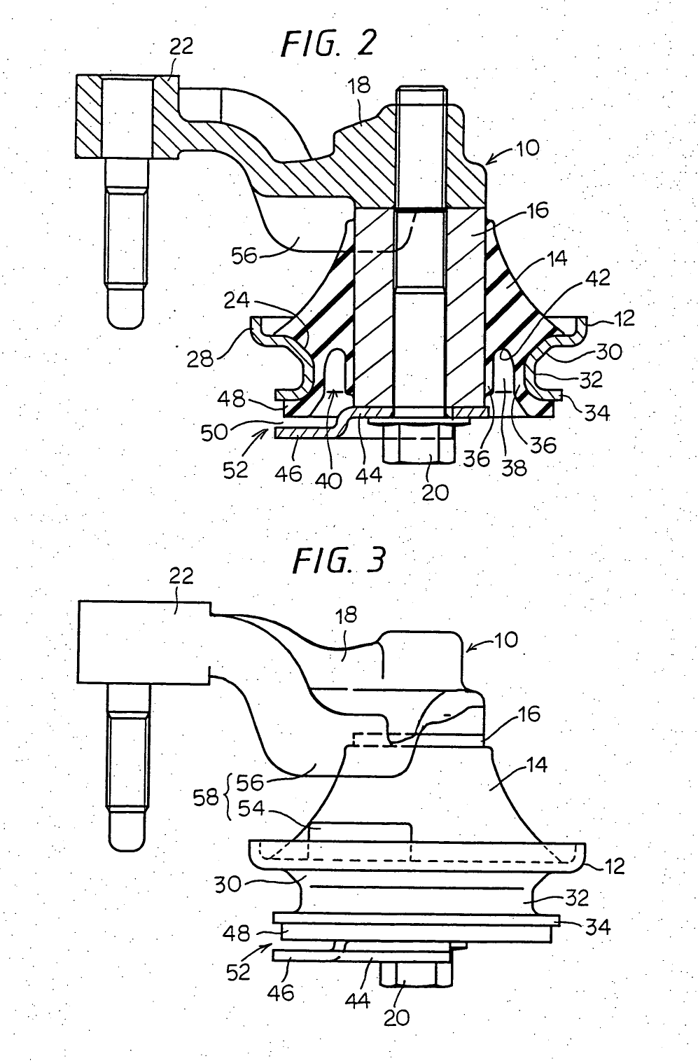

As illustrated in FIG. 2, between the cylindrical portion 32 of the second attachment member 12 and the inner cylinder 16, there is provided a stopper rubber 36 while ensuring a predetermined clearance gap 38 in the normal-to-axis direction, thereby forming a first stopper part 40 limiting an excessive displacement of the inner cylinder 16 and the second attachment member 12 in the horizontal direction. The stopper rubber 36 in this embodiment is provided so as to cover both the outer peripheral face of the inner cylinder 16 and the inner peripheral face of the cylindrical portion 32 opposing it, and is formed of the rubber linking from the vibration-isolating base 14. In this embodiment, a recessed portion 42 is thus formed in a fashion such that the underside of the vibration-isolating base 14 is axially hollowed out over the whole circumference thereof, and the clearance gap 38 as a stopper clearance is set by the width (size in the normal-to-axis direction) of the recessed portion 42.

At the lower end of the inner cylinder 16, a stopper fitting 44 is fastened by means of the bolt 20. The stopper fitting 44 assumes, as shown in FIG. 1, a semi-disk-like shape and is provided, as shown in FIG. 2, with an extension portion 46 extending outwardly beneath the flange portion 34 at the lower end of the cylindrical portion 32. Between the extension portion 46 and the flange portion 34, a stopper rubber 48 is disposed while ensuring a predetermined clearance gap 50 in the axial direction, thereby forming a second stopper part 52 limiting an upward excessive displacement of the inner cylinder 16 to the second attachment member 12. The stopper rubber 48 in this embodiment is formed of the rubber linking from the stopper rubber 36 which covers the inner peripheral face of the cylindrical portion 32 so as to cover the underside of the flange portion 34.

FIG. 2 shows the clearance gap 50 in an unloaded condition where a load of the engine is not applied. The clearance gap 50 suffices to be set so that a required dimension thereof may be ensured when the load of the engine is loaded. As a consequence, the stopper rubber 48 and the extension portion 46 may be in abutment on each other upon unloading. The second stopper part 52 in this embodiment is provided only in an approximately half area a full circumferential area of the cylindrical portion 32, but may also be provided over the full circumferential area.

As shown in FIGS. 1, 3 and 4, on the upside of the second attachment member 12 in the vicinity of the opening 24 there are disposed stopper rubbers 54 in a block form. The stopper rubbers 54 are disposed in respective areas extending from the opening 24 of the second attachment member 12 to the two fitting face portions 26 outside the opening. The stopper rubber 54 is formed of the rubber linking contiguously from the vibration-isolating base 14, and secured to the upside of the second attachment member 12 by vulcanization bonding means, accordingly.

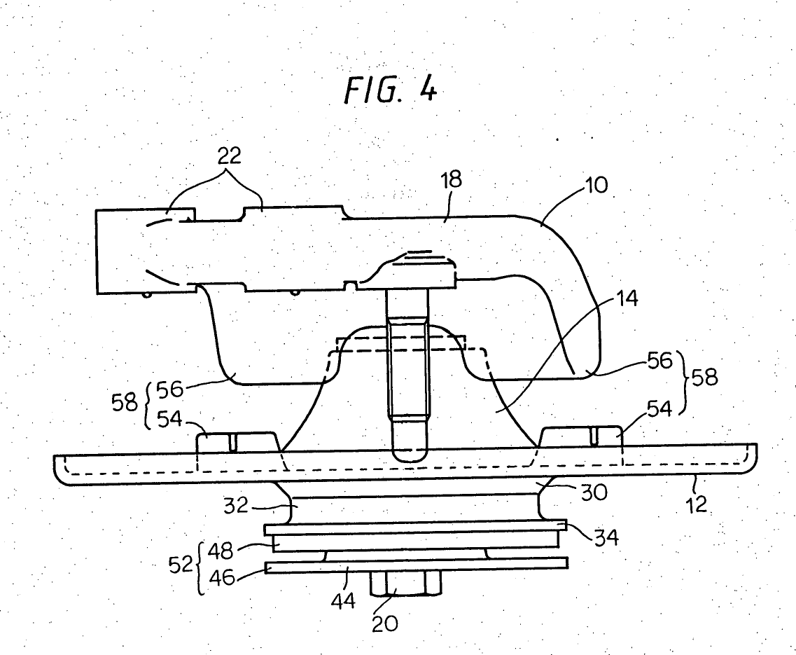

The bracket 18 of the first attachment member 10 is provided with stopper receiving portions 56 projecting downwardly, which oppose the stopper rubbers 54 through a predetermined clearance gap. The stopper rubber 54 and the stopper receiving portion 56 constitute a third stopper part 58 limiting a downward displacement of the first attachment member 10 toward the second attachment member 12. Here, the third stopper part 58 is illustrated in FIGS. 3 and 4 in an unloaded condition of the engine, and it will suffice that the clearance gap between the stopper rubber 54 and the stopper receiving portion 56 is ensured to have a predetermined dimension when the load of the engine is exerted.

The vibration-isolating device thus constructed above is, in its installed condition, loaded by the load of the engine, whereby the clearance gap 50 at the second stopper part 52 and the clearance gap at the third stopper part 58 are ensured by respective predetermined dimensions. For instance, it is possible to set both clearance gaps to be on the order of respective 7 mm. On the other hand, the clearance gap 38 at the first stopper part 40 is set by the width of the recessed portion 42, and consequently, little changed in dimension irrespective of the presence or absence of the load of engine. It is thus possible to set, for example, on the order of 5 mm.

In service condition of the vibration-isolating device, against normal vibrations from the engine or the vehicle body, the vibration-isolating base 14 can damp the vibrations.

And when an excessive displacement of the inner cylinder 16 in the horizontal direction takes place, the first stopper part 40 performs a stopper action by abutment of the inner cylinder 16 onto the cylindrical portion 32 through the stopper rubber 36, limiting further displacement. At that time, being formed over a full circumference of the inner cylinder 16, the first stopper part 40 can perform the stopper action to an excessive displacement in the lateral direction as well as an excessive displacement in the fore and aft direction of the vehicle as heretofore.

On the other hand, when an upward excessive displacement to the inner cylinder 16 is generated, the extension portion 46 of the stopper fitting 44 at the lower end of the inner cylinder 16 abuts on the flange portion 34 above the extension portion through the second stopper rubber 48, whereby the second stopper 52 can perform a stopper action, limiting a further upward displacement.

Further when a downward excessive displacement of the inner cylinder 16 is generated, the stopper receiving portions 56 of the bracket 18 abut on the stopper rubbers 54 disposed downwards at the third stopper parts 58, whereby a stopper action is performed, limiting further downward displacement.

By the vibration-isolating device in the present embodiment as described above, it is possible to exhibit a stopper action limiting a horizontal excessive displacement because of a simple structure constructed for the second attachment member 12, and concurrently to further exhibit a stopper action limiting an upward excessive displacement because of compactness of the stopper fitting 44 provided on the inner cylinder 16 of the first attachment member 10. Consequently, due to its much more compactified and weight-reduced structure as compared with the conventional structure, the vibration-isolating device is capable of exhibiting stopper actions to upward and horizontal excessive displacements of the vibration-isolating base 14.

### Second Embodiment

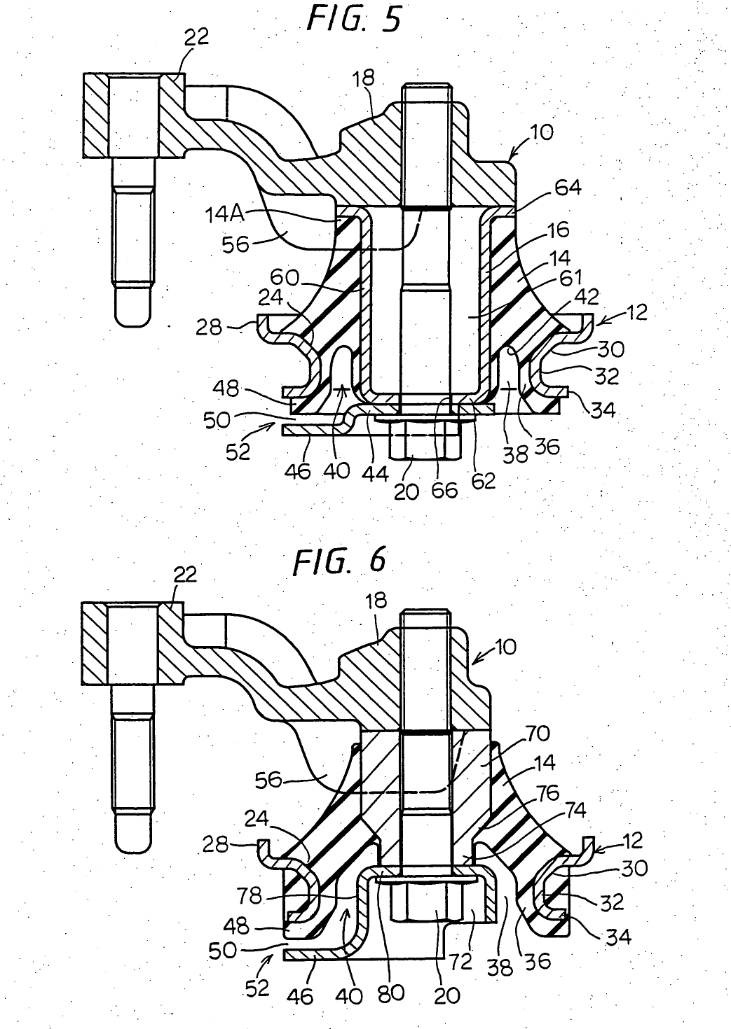

A second embodiment as illustrated in FIG. 5 is different from the first embodiment described above in the construction of the inner cylinder 16 at the first attachment member 10, but the same as the first embodiment in other constructions, whose description therefore will be omitted.

In the second embodiment, for the inner cylinder 16 a press working product of a metal plate is employed. That is, the inner cylinder 16 is comprised of a cylindrical main body 60 surrounding the bolt 20 entered therethrough to be spaced apart a predetermined void 61, a bottom plate portion 62 which is an attachment face to the stopper fitting 44 disposed at the lower end of the cylindrical main body 60, and an outwardly facing, full-circumferential flange portion 64 which is an attachment face to the bracket 18 disposed at the upper end of the cylindrical main body 60, these three being fashioned integrally by press working of metal plate. The bottom plate portion 62 has a through-hole 66 entered by the bolt 20 in its central area.

Since the inner cylinder 16 is fabricated by press working of metal plate in this manner and the void 61 is defined between the cylindrical main body 60 and the bolt 20, a further weight reduction of the vibration-isolating device can be achieved. Moreover because an upper end portion 14A of the vibration-isolating base 14 is provided to extend up to the underside of the flange portion 64, a downward load by an engine can be received by the flange portion 64.

### Third Embodiment

A third embodiment as shown in FIG. 6 is different from the foregoing first embodiment in the construction of the first attachment member 10 and the same as the first embodiment in other constructions, whose description will be omitted, accordingly.

In the third embodiment, the shank part of the first attachment member 10 is made up of two members: a first inner cylinder 70, on the upper side, connected through the vibration-isolating base 14 to the second attachment member 12 and a second inner cylinder 72 forming the first stopper part 40 together with the cylindrical portion 32 of the second attachment member 12.

The first inner cylinder 70 is fixed at its upper end to the underside of the bracket 18 by means of the bolt entered therethrough and terminated at its lower end with a height near the tapered face portion 30 of the second attachment member 12. The first inner cylinder 70 is set to be smaller in outside diameter at its lower end portion 74 whereas a tapered portion 76 located between an axially central portion and the lower end portion 74 is set to be gradually smaller in outside diameter toward the lower side so as to have a nearly parallel slanting face to the slanting face of the tapered face portion 30.

The second inner cylinder 72 is made up of a short cylindrical main body 78 disposed to oppose the inner periphery of the cylindrical portion 32 of the second attachment member 12, an upper plate portion 80 constituting an attachment face to the first inner cylinder 70 disposed at the upper end of the main body 78, and the extension portion 46 provided at the lower end of the main body 78 constituting the second stopper part 52, these being fashioned integrally by press working of metal plate. As a consequence, the second inner cylinder 72 serves as the shank part constituting the first stopper part 40 and concurrently as the stopper fitting 44 in the first embodiment. The second inner cylinder 72 is fastened to the lower end of the first inner cylinder 70 by means of the bolt 20.

In the third embodiment, the shank part of the first attachment member is thus divided vertically into two members, wherein the first inner cylinder 70 on the upper side is constituted as a joint part to the vibration-isolating base 14 and the second inner cylinder 72 on the lower side is constituted as a stopper fitting forming the first and second stopper parts 40, 52. Because of the constitution, it is possible to ensure a free length of the rubber on the under side of the vibration-isolating base 14, thus enhancing the durability of the rubber. Specifically stated, in the first embodiment, the recessed portion 42 is formed below the vibration-isolating base 14 to ensure the clearance gap 38 of the first stopper part 40; and in order to make the dimension of the clearance gap 38 a predetermined dimension, therefore, there is no choice but to make the radius of curvature at the bottom of the recessed portion 42 small and accordingly, the free length of the rubber in the vicinity of the bottom is short, as a result of which it is likely to pose a problem in the durability of the rubber. In contrast, according to the third embodiment, the shank part is divided into two members, whereby irrespective of the outside diameter of the second inner cylinder 72 and accordingly, while ensuring the clearance gap 38 of a required dimension for the first stopper part 40 at the second inner cylinder 72, it is possible to make the lower end portion 74 of the first inner cylinder 70 smaller in diameter, thereby increasing the free length of the rubber on the under side of the vibration-isolating base 14.

### Fourth Embodiment

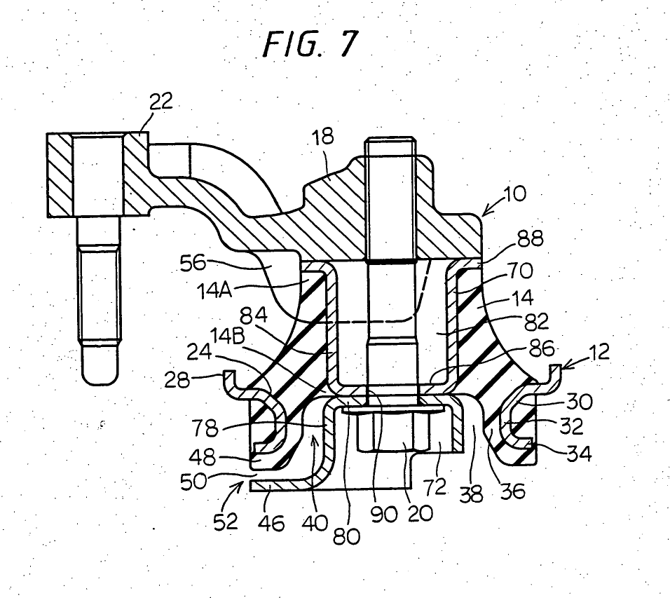

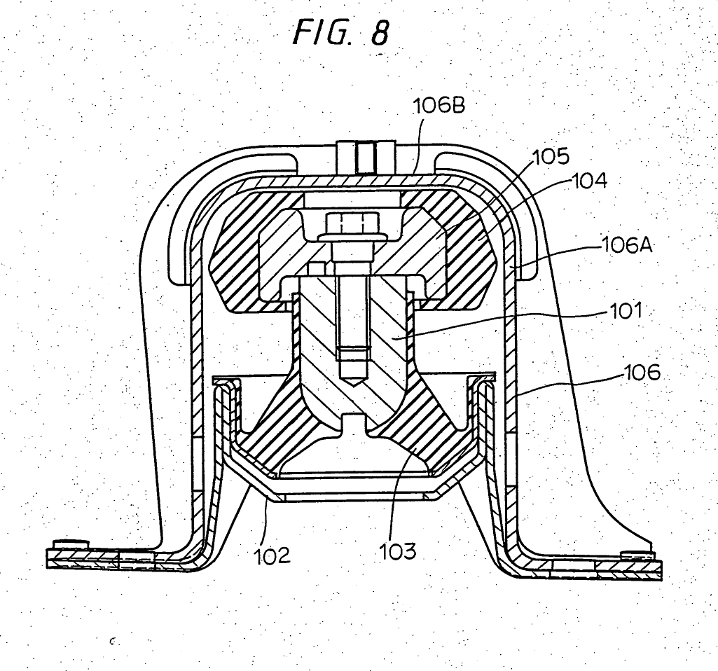

As shown in FIG. 7, a fourth embodiment is the same as the third embodiment above except for the construction of the first inner cylinder 70 at the first attachment member 10, and the description on the other constructions than that construction will be omitted, accordingly.

In the fourth embodiment, a press working product of a metal plate is used for the first inner cylinder 70. That is, the first inner cylinder 70 includes a cylindrical main body 84 surrounding the bolt 20 entered internally therethrough so as to be spaced apart a predetermined gap 82 from the bolt, a bottom plate portion 86 disposed at the lower end of the main body 84 to constitute an attachment face to the second inner cylinder 72, and an outwardly facing full-circumferential flange portion 88 disposed at the upper end of the main body 84 to constitute an attachment face to the bracket 18, with these elements formed integrally by press working of a metal plate. The bottom plate portion 86 is provided in its central area with a through-hole 90, through which the bolt 20 is entered.

Due to the fact that the first inner cylinder 70 is thus fabricated by press working of a metal plate and the void 82 is defined between the cylindrical main body 84 and the bolt 20, a further reduction in weight of the vibration-isolating device can be achieved. In addition, since the upper end portion 14A of the vibration-isolating base 14 extends up to the underside of the flange portion 88 so as to be fitted to the underside, a downward load by an engine can be received by the flange portion 88.

Here in the fourth embodiment, the lower end portion of the first inner cylinder 70 is not made smaller in diameter as is the case with the third embodiment. Nevertheless the shank part is made up of two members divided, whereby a lower end portion 14B on the inner peripheral side of the vibration-isolating base 14 can be configured to extend horizontally facing inwards, without the necessity of adopting, as is the case with the first embodiment, such a sectional shape that the lower end portion of the vibration-isolating base is turned back downwardly along the outer peripheral face of the inner cylinder 16. Therefore it is possible to enhance the durability of rubber on the underside of the vibration-isolating base 14.

### INDUSTRIAL APPLICABILITY

According to this invention, it is possible to provide a vibration-isolating device having a stopper mechanism to excessive displacements of its vibration-isolating base in both upward and horizontal directions, as a lightweight product at a reduced cost, whereby it is possible to contribute to a drift toward a lower fuel consumption and a lower cost of automobiles.

1.-7. (canceled)

8. A vibration-isolating device comprising a first attachment member comprising a shank portion to be attached to a vibratory body side, with its axis direction oriented in the vertical direction; a second attachment member having an opening surrounding the shank portion to be attached to a support body side; a vibration-isolating base made of a rubber-like elastomer interposed between the shank portion of the first attachment member and the opening of the second attachment member to connect the both thereby elastically supporting the first attachment member to the second attachment section in the vertical direction,
a cylindrical portion extending downwardly from an opening edge of the opening and a first stopper rubber formed between the cylindrical portion and the shank portion while ensuring a predetermined clearance gap in a square direction to the axis direction, thereby providing a first stopper part limiting a horizontal displacement;
an extension portion extending from a lower end of the shank portion to face outwardly beneath the cylindrical portion and a second stopper rubber formed between the extension portion and a lower end of the cylindrical portion, while ensuring a predetermined clearance gap, thereby providing a second stopper part limiting an upward displacement of the first attachment member to the second attachment member;
said first attachment member being provided with a bracket connecting the shank portion to the vibratory body side;
said shank portion being constructed of a first inner cylinder that is connected through the vibration-isolating base to the second attachment member and a second inner cylinder that forms said first stopper part between the second inner cylinder and the cylindrical portion of the second attachment member and is provided at its lower end with said extension portion;
said first inner cylinder is fixed, at its upper end, to the bracket and, at its lower end, to the second inner cylinder by means of a bolt entered internally therethrough.

9. The vibration-isolating device as set forth in claim 8, wherein said first inner cylinder is configured by press working of a metal plate into a cylindrical form surrounding the bolt through a predetermined void and is provided with a bottom plate portion having a through-hole for the bolt at its lower end and an outwardly facing flange portion abutting on the underside of the bracket at its upper end.
